(19) United States
(12) Patent Application Publication
(10) Pub. No.: US 2023/0018988 A1
(43) Pub. Date: Jan. 19, 2023

(54) SILANIZED BORON NITRIDE COMPOSITE AND PREPARATION METHOD THEREFOR

(71) Applicant: DEFENSE AGENCY FOR TECHNOLOGY AND QUALITY, Gyeongsangnam-do (KR)

(72) Inventor: Man Tae Kim, Gyeongsangnam-do (KR)

(21) Appl. No.: 17/786,053

(22) PCT Filed: Dec. 14, 2020
(86) PCT No.: PCT/KR2020/018275

§ 371 Date: Jun. 16, 2022

(30) Foreign Application Priority Data
Dec. 17, 2019 (KR) 10- 2019- 0168544

(51) Int. Cl. C01B 21/064; C08K 9/06; C08K 3/38

(52) U.S. Cl. CPC C01B 21/0648; C08K 9/06; C08K 3/38; C08K 2003/385

(57) ABSTRACT

The present application relates to a silanized boron nitride composite and a preparation method thereof, and more specifically, to a silanized boron nitride composite, which exhibits excellent mechanical properties and excellent thermal conductivity by realizing excellent dispersibility and improved affinity for epoxy through silane surface treatment, and a preparation method thereof.

### TECHNICAL FIELD

The present application relates to a silanized boron nitride composite and a preparation method thereof, and more specifically, to a silanized boron nitride composite, which exhibits excellent mechanical properties and excellent thermal conductivity by realizing excellent dispersibility and improved affinity for epoxy through silane surface treatment, and a preparation method thereof.

### BACKGROUND ART

Electronic devices are becoming more complex as high density and high frequency are required. Since electronic devices inevitably generate heat and require size reduction and high performance in modern times, they are designed to generate more heat in a small space. To ensure the proper operation and reliability of electronic devices, the generated heat needs to be quickly removed, and therefore, the packaging materials of electronic devices need to have good thermal conductivity and excellent mechanical properties.

Meanwhile, heat dissipation material technologies using metal materials were conventionally commonly used for heat dissipation materials, but high-performance composite materials into which fillers having high thermal conductivity are inserted are in the spotlight now. However, since epoxy-based composites, which are insulators, have low thermal conductivity, it is difficult to use the epoxy-based composite alone. Therefore, thermal properties can be expected to be improved by inserting reinforcing materials having high thermal conductivity as fillers. Among them, boron nitride has attracted great attention as an excellent material due to having high thermal conductivity, low toxicity, excellent chemical stability, and insulating properties.

However, when the composites do not exhibit excellent adhesion to an interface, they are present as internal defects, which affect mechanical properties and do not allow the realization of excellent thermal conductivity.

Various studies for solving the above problems are needed.

### RELATED-ART DOCUMENTS

### Patent Documents

(Patent Document 1) Korean Laid-Open Patent Publication No. 10-2016-0120475 (published on Oct. 18, 2016)

### DISCLOSURE

### Technical Problem

The present application is directed to providing a silanized boron nitride composite, which exhibits excellent thermal conductivity and excellent mechanical properties by improving affinity of boron nitride for an epoxy interface and increasing dispersibility, and a preparation method thereof.

### Technical Solution

One aspect of the present application provides a method of preparing a silanized boron nitride composite.

In an example, the method includes: a pre-treatment step of oxidizing boron nitride using a first mixed solution including sulfuric acid and sodium nitrate to form oxidized boron nitride powder; a silanization step of silanizing the oxidized boron nitride with a silane derivative to form silanized boron nitride; and a mixing step of mixing the silanized boron nitride with a first mixture including an epoxy resin and a curing agent to form a second mixture and curing the second mixture to form a composite.

In an example, the pre-treatment step may include: adding boron nitride to the first mixed solution to form a second mixed solution; stirring the second mixed solution at 3 to 10° C. for 3 to 5 hours; mixing the stirred second mixed solution with water and acetone so that the second mixed solution becomes neutral; and drying the neutralized mixed solution at 60 to 80° C. for 10 to 12 hours to form pre-treated boron nitride powder.

In an example, the boron nitride may include at least one selected from the group consisting of hexagonal boron nitride, sphalerite boron nitride, cubic boron nitride, and wurtzite boron nitride.

In an example, the silanization step may include: mixing the oxidized boron nitride powder with ethyl alcohol, ultrapure water, and a silane derivative to form a third mixed solution; stirring the third mixed solution at 80 to 120° C. for 6 to 8 hours; mixing the stirred third mixed solution with water and acetone to form a fourth mixed solution; and drying the fourth mixed solution in a vacuum oven at 70 to 90° C. for 10 to 12 hours.

In an example, a content ratio of the ethyl alcohol, ultrapure water, oxidized boron nitride, and silane derivative in the third mixed solution may be 60 to 70 parts by weight:10 to 20 parts by weight:1 to 10 parts by weight:1 to 3 parts by weight.

In an example, the silane derivative may be 3-aminopropyltriethoxysilane or 3-isocyanatopropyltrimethoxysilane.

In an example, the mixing step may include: mixing the silanized boron nitride with a first mixture including an epoxy resin and a curing agent to form a second mixture; stirring the second mixture for 30 to 60 minutes; and curing the stirred second mixture at 60 to 80° C. for 2 to 3 hours to form a composite.

In an example, a content ratio (v/v) of the epoxy resin and curing agent in the first mixture may be 1:1 to 3:2.

Another aspect of the present application provides a silanized boron nitride composite prepared by the above-described method.

### Advantageous Effects

According to an embodiment of the present application, silanized boron nitride having excellent affinity for a polymer can be provided.

According to an embodiment of the present application, silanized boron nitride having excellent dispersibility in a polymer can be provided.

According to an embodiment of the present application, a silanized boron nitride composite having excellent thermal conductivity can be provided.

According to an embodiment of the present application, a silanized boron nitride composite having excellent mechanical properties can be provided.

According to an embodiment of the present application, a silanized boron nitride composite highly applicable to electronic products and heat-resistant parts of aircrafts can be provided.

According to an embodiment of the present application, a silanized boron nitride composite which has a great economic ripple effect when applied to parts favorable for the high strength, light weight, and heat resistance of aircraft as a composite material-related technology.

### DESCRIPTION OF DRAWINGS

FIG. 1 shows the powder, scanning electron microscope (SEM) image, and schematic diagram of the crystal structure of boron nitride.

FIG. 2 shows a flowchart for illustrating a method of preparing a silanized boron nitride composite according to an embodiment of the present application.

FIG. 3 shows a schematic diagram for illustrating a pre-treatment step in a method of preparing a silanized boron nitride composite according to an embodiment of the present application.

FIG. 4 shows a schematic diagram for illustrating a silanization step in a method of preparing a silanized boron nitride composite according to an embodiment of the present application.

FIG. 5 shows a schematic diagram for illustrating a mixing step in a method of preparing a silanized boron nitride composite according to an embodiment of the present application.

FIG. 6 shows graphs illustrating a Fourier transform infrared spectroscopy result of a silanized boron nitride composite according to an embodiment of the present application.

FIG. 7 shows a graph illustrating a measurement result of the thermal conductivity of a silanized boron nitride composite according to an embodiment of the present application.

FIG. 8 shows a graph illustrating a measurement result of the tensile strength of a silanized boron nitride composite according to an embodiment of the present application.

FIG. 9 shows a graph illustrating a measurement result of the flexural strength of a silanized boron nitride composite according to an embodiment of the present application.

FIG. 10 shows SEM images of a silanized boron nitride composite according to an embodiment of the present application.

### MODES OF THE INVENTION

The terms of the present application have been used only for the purpose of describing particular exemplary embodiments and are not intended to limit the present invention. In the present specification, singular expressions include plural expressions unless the context clearly indicates otherwise. It will be further understood that the terms “comprises,” “comprising,” “includes,” “including,” “has”, or “having” used herein specify the presence of stated features, components, and the like, but do not preclude the presence or addition of one or more other features, components, and the like.

The term “first”, “second”, and the like used herein are not used to indicate an order, but are merely used to indicate different materials or steps.

Unless defined otherwise, all terms used herein, including technical or scientific terms, have the same meaning as commonly understood by one of ordinary skill in the art to which the present invention pertains. Terms such as those defined in the commonly used dictionaries should be construed as having meanings consistent with the meanings in the context of the related art and are not to be interpreted in an ideal or overly formal sense unless explicitly defined in the present application.

Hereinafter, a silanized boron nitride composite and a preparation thereof according to the present application will be described in detail with reference to the accompanying drawings. However, the accompanying drawings are only exemplary, and the scope of the silanized boron nitride composite and preparation thereof according to the present application is not limited by the accompanying drawings.

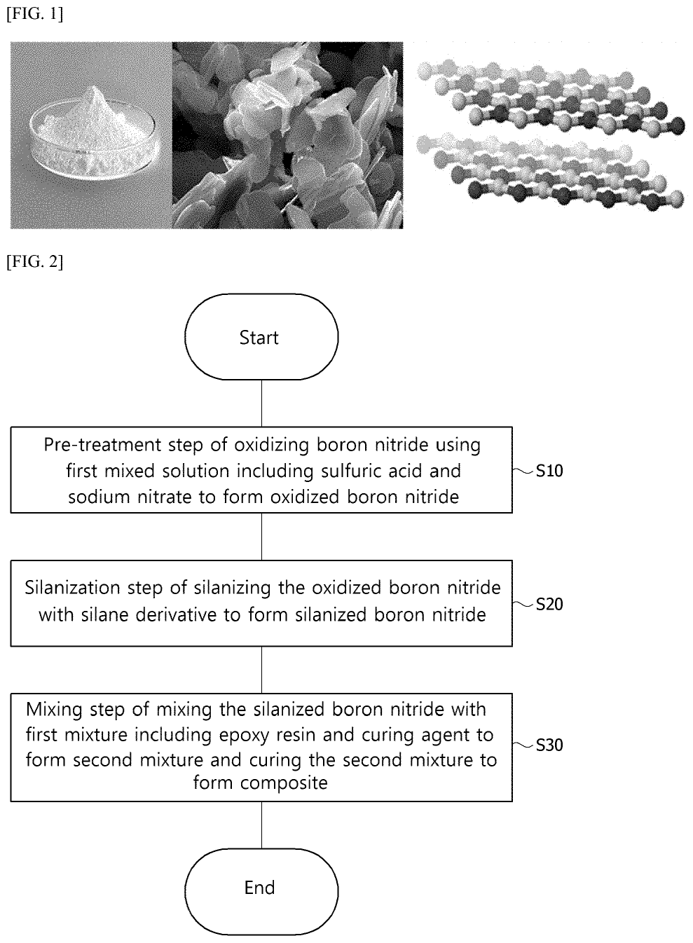

FIG. 1 shows the powder, scanning electron microscope (SEM) image, and schematic diagram of the crystal structure of boron nitride. As shown in FIG. 1, boron nitride may be present in the form of powder and has a platy structure. Compared with metal materials, boron nitride having a hexagonal platy structure exhibits excellent thermal conductivity in the horizontal direction and thus is suitable as a heat dissipation filler. Also, a polymer composite material using boron nitride has advantages such as processability, light weight, and a low cost and particularly exhibits both insulating properties and high thermal conductivity, and therefore, it is particularly suitable as a heat dissipation material. However, since the adhesion between the polymer and the boron nitride filler is poor, the physical properties and thermal properties of a composite material are degraded. To overcome the above problem, the present application is directed to providing a polymer composite material, which exhibits improved thermal conductivity and improved mechanical properties by improving adhesion to epoxy and dispersibility in epoxy through silanization of boron nitride.

Hereinafter, a method of preparing a silanized boron nitride composite will be described.

FIG. 2 shows a flowchart for illustrating a method of preparing a silanized boron nitride composite according to an embodiment of the present application.

As shown in FIG. 2, the method includes: a pre-treatment step (S100) of oxidizing boron nitride using a first mixed solution including sulfuric acid and sodium nitrate to form oxidized boron nitride powder; a silanization step (S200) of silanizing the oxidized boron nitride with a silane derivative to form silanized boron nitride; and a mixing step (S300) of mixing the silanized boron nitride with a first mixture including an epoxy resin and a curing agent to form a second mixture and curing the second mixture to form a composite.

Hereinafter, each step of the preparation method according to the present application will be described in detail.

Pre-Treatment Step (S100)

Boron nitride is oxidized using a first mixed solution including sulfuric acid and sodium nitrate to form oxidized boron nitride powder.

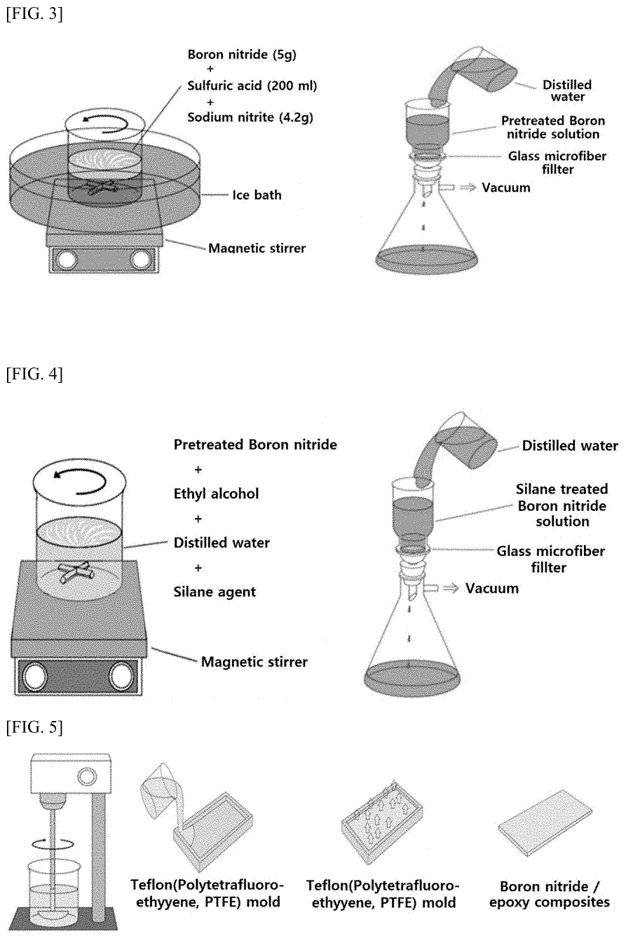

FIG. 3 shows a schematic diagram for illustrating the pre-treatment step in the method of preparing a silanized boron nitride composite according to an embodiment of the present application.

As shown in FIG. 3, boron nitride is oxidized by mixing boron nitride with a first mixed solution including sulfuric acid, which is a strong acid, and sodium nitrate.

Specifically, the pre-treatment step may include: adding boron nitride to a first mixed solution including sulfuric acid and sodium nitrate to form a second mixed solution; stirring the second mixed solution at 3 to 10° C. for 3 to 5 hours; mixing the stirred second mixed solution with water and acetone so that the second mixed solution becomes neutral; and drying the neutralized mixed solution at 60 to 80° C. for 10 to 12 hours to form pre-treated boron nitride powder.

Boron nitride, which is boron nitride with the chemical formula BN, has a hexagonal structure similar to graphite, and thus the chemical and physical properties thereof are similar to those of graphite. Boron nitride is a white electrically excellent insulator. In this case, boron nitride may include at least one selected from the group consisting of hexagonal boron nitride, sphalerite boron nitride, cubic boron nitride, and wurtzite boron nitride.

The pre-treatment process for silanization may use sulfuric acid, sodium nitrite obtained by a reaction of sodium carbonate and sodium hydroxide, and the like.

In this case, the mixing with water and acetone is preferably performed so that a pH becomes 6 to 8.

Through the pre-treatment step, boron nitride may be converted into oxidized boron nitride.

Silanization Step (S200)

Next, the oxidized boron nitride is silanized with a silane derivative to form silanized boron nitride.

FIG. 4 shows a schematic diagram for illustrating the silanization step in the method of preparing a silanized boron nitride composite according to an embodiment of the present application.

As shown in FIG. 4, the pre-treated boron nitride powder may be mixed with ethyl alcohol, ultrapure water, and a silane derivative to silanize boron nitride.

In an example, the silanization step may include: mixing the oxidized boron nitride powder with ethyl alcohol, ultrapure water, and a silane derivative to form a third mixed solution; stirring the third mixed solution at 80 to 120° C. for 6 to 8 hours; mixing the stirred third mixed solution with water and acetone to form a fourth mixed solution; and drying the fourth mixed solution in a vacuum oven at 70 to 90° C. for 10 to 12 hours.

A content ratio of the ethyl alcohol, ultrapure water, oxidized boron nitride, and silane derivative in the third mixed solution preferably is 60 to 70 parts by weight:10 to 20 parts by weight:1 to 10 parts by weight:1 to 3 parts by weight. The silanization step may be optimally performed using this content ratio.

In addition, the silane derivative may be 3-aminopropyltriethoxysilane or 3-isocyanatopropyltrimethoxysilane.

Mixing Step (S300)

Next, the silanized boron nitride is mixed with a first mixture including an epoxy resin and a curing agent to form a second mixture, and the second mixture is cured to form a composite.

FIG. 5 shows a schematic diagram for illustrating the mixing step in the method of preparing a silanized boron nitride composite according to an embodiment of the present application.

As shown in FIG. 5, the silanized boron nitride may be mixed with a first mixture including an epoxy resin and a curing agent to form a composite.

The mixing step may include: mixing the silanized boron nitride with a first mixture including an epoxy resin and a curing agent to form a second mixture; stirring the second mixture for 30 to 60 minutes; and curing the stirred second mixture at 60 to 80° C. for 2 to 3 hours to form a composite.

In an example, a content ratio (v/v) of the epoxy resin and curing agent in the first mixture may be 1:1 to 3:2.

The curing agent is not particularly limited, and any curing agent that is applicable to an epoxy resin or the like may be used.

As shown in FIG. 5, the formed second mixture may be input into a mold and cured to form a composite including boron nitride and an epoxy resin.

Another aspect of the present application provides a silanized boron nitride composite prepared by the above-described method.

Through a series of steps, a silanized boron nitride/epoxy composite, which exhibits excellent mechanical properties and excellent thermal conductivity by realizing excellent dispersibility and improved affinity for epoxy through silane surface treatment, can be prepared.

Specifically, according to the method of preparing an epoxy composite using a silanized boron nitride filler after the pre-treatment, compared with conventional pre-treatment and silane surface modification methods, a composite whose mechanical properties and thermal conductivity are improved by improving dispersibility of the reinforcing material and adhesion of the reinforcing material to an epoxy interface through attachment of an excellent silane functional group can be prepared and replace a conventional composite whose mechanical properties and thermal conductivity are poor. Therefore, it may be used in various industrial fields.

Hereinafter, the present application will be described in further detail with reference to experimental examples.

### EXAMPLE AND COMPARATIVE EXAMPLES

5 to 10 g of hexagonal boron nitride was mixed with 200 to 300 ml of sulfuric acid (H₂SO₄) and 3 to 7 g of sodium nitrate, the mixture was stirred at 5 to 10° C. for 3 to 5 hours, and the resulting mixed solution was mixed with distilled water (99.5%, Daejung Chemicals, Korea) and acetone (99.5%, Daejung Chemicals, Korea) until a neutral pH of 6 to 7 was reached. Then, the resulting mixed solution was dried for 10 to 12 hours while maintaining a temperature of 60 to 80° C. to prepare pre-treated boron nitride powder.

300 to 400 ml of ethyl alcohol and 80 to 100 ml of ultrapure water (DI water) were used to prepare a mixed solution, 5 to 10 ml of a silane derivative selected from 3-aminopropyltriethoxysilane and 3-isocyanatopropyltrimethoxysilane was added, 5 to 10 g of the pre-treated boron nitride was added, and then the resulting mixed solution was stirred at 80 to 120° C. for 8 to 10 hours, mixed with distilled water (99.5%, Daejung Chemicals, Korea) and acetone (99.5%, Daejung Chemicals, Korea), and dried at 70 to 90° C. for 10 to 12 hours.

1 wt %, 5 wt %, and 10 wt % of the silanized boron nitride was each mixed with a mixture including diglycidyl ether of bisphenol A (DGBA) as an epoxy resin and polyamidoamine in a content ratio (v/v) of 1:1 to 3:2 to prepare a boron nitride/epoxy composite.

Raw boron nitride was used to prepare a boron nitride/epoxy composite, the pre-treated boron nitride was used to prepare a boron nitride/epoxy composite, and additional experiments were conducted using these boron nitride/epoxy composites as comparative examples.

### Experimental Example 1

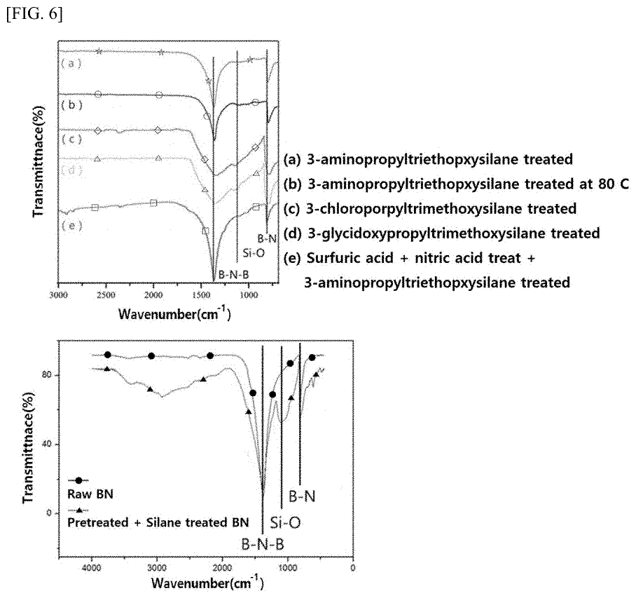

In order to observe functional groups on the surface according to the pre-treatment and silane treatment of boron nitride, the raw boron nitride, pre-treated boron nitride, and silanized boron nitride were analyzed by Fourier transform infrared spectroscopy (FT-IR). Results thereof are shown as graphs in FIG. 6.

As shown in FIG. 6, it can be confirmed that the raw boron nitride whose surface had not been treated exhibited a peak corresponding to a B—N—B bond due to the Van der Waals bond at 815 cm⁻¹ and 1374 cm⁻¹. It can also be confirmed that the silane-treated boron nitride exhibited Si—O—C bonding at 1101 cm⁻¹, and thus the silane group was well formed on the surface of boron nitride compared with other documents.

### Experimental Example 2

In order to compare thermal conductivity, the thermal conductivity of the raw boron nitride/epoxy composite and the silanized boron nitride composite were measured. The measurement was made by heating the surface of the sample with laser pulses by a laser flash method, measuring a change in temperature of the rear surface of the sample over time using an infrared thermometer to calculate thermal diffusivity, and measuring thermal conductivity according to density.

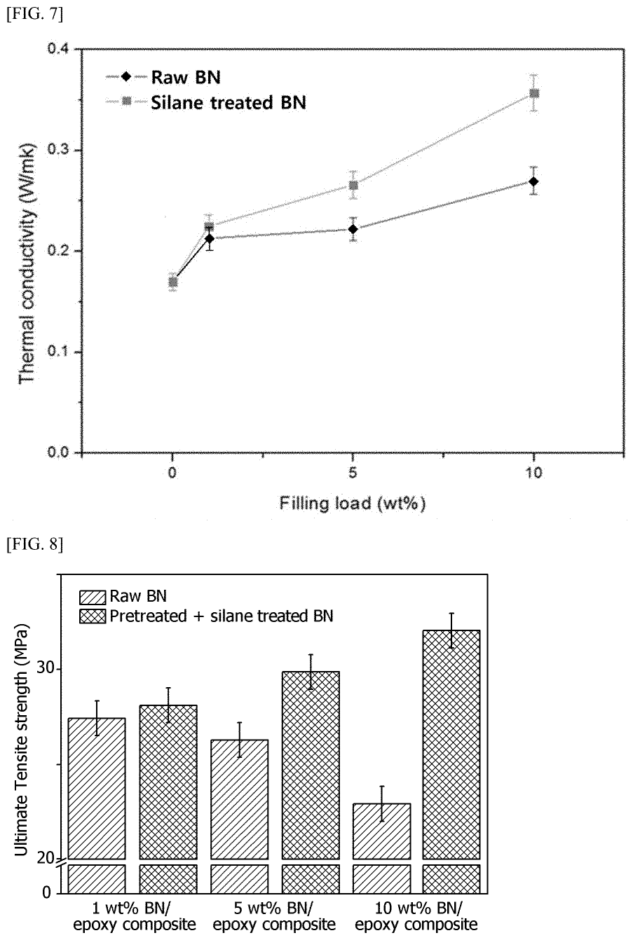

The raw boron nitride (whose surface had not been treated)/epoxy composite and the silanized boron nitride (whose surface had been treated with silane)/epoxy composite were analyzed according to the content (1 wt %, 5 wt %, and 10 wt %) of boron nitride. Results thereof are shown as a graph in FIG. 7.

As shown in FIG. 7, in the case of the raw boron nitride/epoxy composite, boron nitride exhibited a thermal conductivity of 0.27 W/mk, which was increased about 60% compared to 0.17 W/mk of epoxy, and in the case of the composite using pre-treated boron nitride, a thermal conductivity of 0.227 W/mk was exhibited, which was increased about 33% compared to epoxy but decreased 16% compared to the raw boron nitride/epoxy composite.

In the case of the silanized boron nitride/epoxy composite, it was confirmed that a thermal conductivity of 0.357 W/mk was exhibited, which was increased 110% compared to epoxy, 32% compared to the raw boron nitride/epoxy composite, and 57% compared to the pre-treated boron nitride/epoxy composite, and thus the thermal conductivity of the silanized boron nitride/epoxy composite was improved. This is considered to be due to the fact that, when pre-treatment and silane surface treatment are performed, the silane group is effectively introduced to the surface to improve dispersibility in epoxy and adhesion to the epoxy interface, and thus the thermal resistance of the interface is decreased.

### Experimental Example 3

In order to examine the effect of silane treatment, the tensile strength of the composite was measured. For a tensile strength test, composites were prepared by including each content (1, 5, and 10 wt %) of boron nitride, and the test was conducted according to a test standard.

The tensile strength test was conducted at a speed of 1 mm/min in accordance with the ASTM D638 test method using a universal testing machine, and at least 5 samples were used to extract statistical data. Results thereof are shown as a graph in FIG. 8.

As shown in FIG. 8, in the case of the silanized boron nitride/epoxy composite, it can be confirmed that tensile strength was improved about 40% compared to the raw boron nitride/epoxy composite, and the tensile strength was improved as the content of boron nitride increased. This is seen as a result of improvement in adhesion to an epoxy interface and dispersibility through silane treatment.

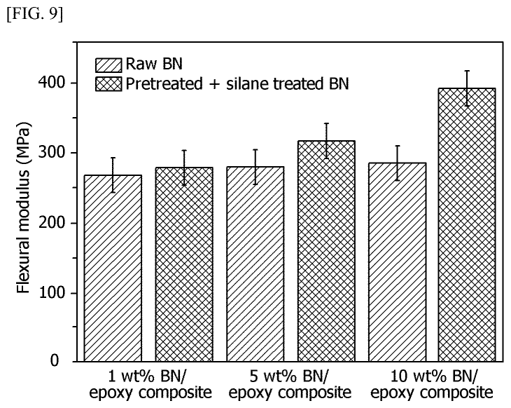

A flexural strength test was conducted at a speed of 0.5 mm/min in accordance with the ASTM D790 test method using a universal testing machine, and at least 5 samples were used to extract statistical data. Results thereof are shown as a graph in FIG. 9.

As shown in FIG. 9, as a result of conducting the test according to a test standard, the silanized boron nitride/epoxy composite exhibited the best flexural strength. However, the effect according to the content of boron nitride was not significant. This is considered to be due to the fact that the crystal structure shape and dispersion direction of boron nitride were not considered.

### Experimental Example 4

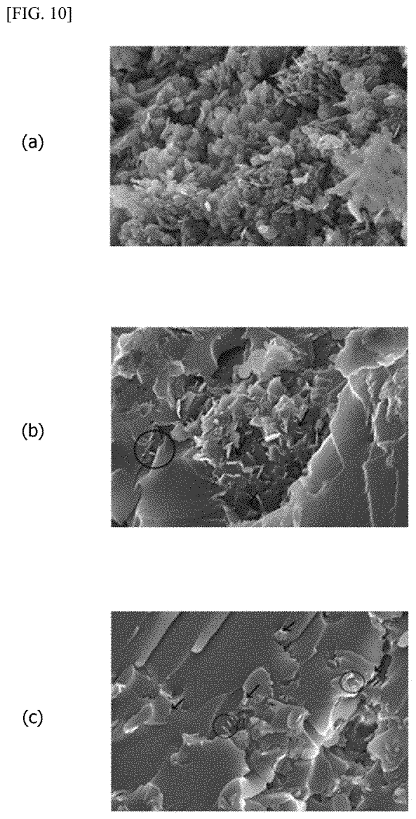

In order to examine the mechanism of fracture, the fracture surface of the material after the tensile test was analyzed using a scanning electron microscope (FE-SEM, LEO SUPRA 55, CARL ZEISS, GERMANY). Images thereof are shown in FIG. 10.

As shown in FIG. 10A, in the case of the fracture surface of the raw boron nitride/epoxy composite, it can be confirmed that uniform dispersion in the matrix was not made, but agglomeration was made. This is considered to be due to the fact that boron nitride particles are aggregated, and thus thermal energy does not pass quickly and stays in the aggregated particles to cause relatively low thermal conductivity. Also, the large particles in the matrix has low adhesion to the epoxy interface, and thus relatively poor mechanical properties are exhibited.

As shown in FIG. 10B, in the case of the fracture surface of the pre-treated boron nitride/epoxy composite, surface activation and dispersibility after the pre-treatment were improved compared to the raw boron nitride/epoxy composite. It can be seen that, since boron nitride has difficulty in forming a chemical bond due to having a planar shape except for the edges of the particles, a superior level of deposition of the silane group on the surface is achieved through pre-treatment compared to other processes.

As shown in FIG. 10C, in the case of the fracture surface of the silanized boron nitride/epoxy composite, it can be confirmed that dispersibility was improved through silane surface treatment. Also, almost no pores were observed between boron nitride and epoxy. This is considered to be due to the fact that the effects of improving adhesion to the epoxy interface and dispersibility result in a decrease in thermal resistance and accordingly an increase in thermal conductivity, and mechanical properties were also improved by a chemical bonding force.

While the present application has been described above with reference to the exemplary embodiments, it may be understood by those skilled in the art that various modifications and alterations may be made without departing from the spirit and scope of the present invention described in the appended claims.

1. A method of preparing a silanized boron nitride composite, comprising:
a pre-treatment step of oxidizing boron nitride using a first mixed solution including sulfuric acid and sodium nitrate to form oxidized boron nitride powder;
a silanization step of silanizing the oxidized boron nitride with a silane derivative to form silanized boron nitride; and
a mixing step of mixing the silanized boron nitride with a first mixture including an epoxy resin and a curing agent to form a second mixture and curing the second mixture to form a composite.

2. The method of claim 1, wherein the pre-treatment step includes:
adding boron nitride to the first mixed solution to form a second mixed solution;
stirring the second mixed solution at 3 to 10° C. for 3 to 5 hours;
mixing the stirred second mixed solution with water and acetone so that the second mixed solution becomes neutral; and
drying the neutralized mixed solution at 60 to 80° C. for 10 to 12 hours to form pre-treated boron nitride powder.

3. The method of claim 1, wherein the boron nitride includes at least one selected from the group consisting of hexagonal boron nitride, sphalerite boron nitride, cubic boron nitride, and wurtzite boron nitride.

4. The method of claim 1, wherein the silanization step includes:
mixing the oxidized boron nitride powder with ethyl alcohol, ultrapure water, and a silane derivative to form a third mixed solution;
stirring the third mixed solution at 80 to 120° C. for 6 to 8 hours;
mixing the stirred third mixed solution with water and acetone to form a fourth mixed solution; and
drying the fourth mixed solution in a vacuum oven at 70 to 90° C. for 10 to 12 hours.

5. The method of claim 4, wherein a content ratio of the ethyl alcohol, ultrapure water, oxidized boron nitride, and silane derivative in the third mixed solution is 60 to 70 parts by weight:10 to 20 parts by weight:1 to 10 parts by weight:1 to 3 parts by weight.

6. The method of claim 1, wherein the silane derivative is 3-aminopropyltriethoxysilane or 3-isocyanatopropyltrimethoxysilane.

7. The method of claim 1, wherein the mixing step includes:
mixing the silanized boron nitride with a first mixture including an epoxy resin and a curing agent to form a second mixture;
stirring the second mixture for 30 to 60 minutes; and
curing the stirred second mixture at 60 to 80° C. for 2 to 3 hours to form a composite.

8. The method of claim 1, wherein a content ratio (v/v) of the epoxy resin and curing agent in the first mixture is 1:1 to 3:2.

9. A silanized boron nitride composite prepared by the method according to claim 1.
